(19) United States
(12) Patent Application Publication
(10) Pub. No.: US 2024/0386302 A1
(43) Pub. Date: Nov. 21, 2024

(54) REDUCING THE EFFECTS OF NOISE ON DISCERNMENT OF QUANTUM STATES BY PHASE SHIFTING

(71) Applicant: International Business Machines Corporation, Armonk, NY (US)

(72) Inventors: Timothy Lindquist, Rochester, MN (US); George Paulik, Rochester, MN (US); George Russell Zettles, IV, Rochester, MN (US); Jarrett Betke, Hoffman Estates, IL (US); Daniel Ramirez, Rochester, MN (US); Austin Carter, Olmsted, MN (US); Kevin Daniel Escobar, Rochester, MN (US); Kevin O'Connell, Mantorville, MN (US)

(21) Appl. No.: 18/199,208

(22) Filed: May 18, 2023

(51) Int. Cl. G06N 10/20

(52) U.S. Cl. CPC G06N 10/20

(57) ABSTRACT

A method, system and computer program product for improving discernment between qubit states in superconducting quantum computers. Channels are calibrated to train the kernel to contain the correct calibration data (“kernel states”). After calibrating a channel, testing is performed in which quantum operations are performed on qubits at the same time in adjacent channels, including the recently calibrated channel, to determine if the kernel response differs from the expected kernel response, where the expected kernel response is based on the kernel states of the trained kernel of the recently calibrated channel, beyond a threshold value. If such a situation occurs, then the phase of the signal for the recently calibrated channel is shifted and the process of recalibrating the channel (using the phase shifted signal) and testing is repeated until the difference between the kernel response and the expected kernel response is not beyond the threshold value.

### TECHNICAL FIELD

The present disclosure relates generally to superconducting quantum computing, and more particularly to improving the discernment between qubit states (e.g., transmon qubit states) in superconducting quantum computers by phase shifting a readout signal to change the influence on the integrated result of the qubit kernel filter.

### BACKGROUND

Superconducting quantum computing is a branch of solid state quantum computing which implements superconducting electronic circuits using superconducting qubits as artificial atoms or quantum dots. For superconducting qubits, the two logic states are the ground state and the excited state, denoted |g [symbol] and |e [symbol] , or |0 [symbol] and |1 [symbol] , respectively.

Superconductors are implemented due to the fact that at low temperatures they have almost infinite conductivity and almost zero resistance. Each qubit is built using semiconductor circuits including Josephson junctions and capacitors.

Superconducting capacitors and Josephson junctions are used to produce a resonant circuit that dissipates almost no energy as heat can disrupt quantum information. The superconducting resonant circuits are a class of artificial atoms that can be used as qubits.

A qubit is a generalization of a bit (a system with two possible states) capable of occupying a quantum superposition of both states. A quantum gate, on the other hand, is a generalization of a logic gate describing the transformation of one or more qubits once a gate is applied given their initial state. Physical implementation of qubits and gates is challenging for the same reason that quantum phenomena are difficult to observe in everyday life given the minute scale on which they occur. One approach to achieving quantum computers is by implementing superconductors whereby quantum effects are macroscopically observable though at the price of extremely low operation temperatures.

A special type of qubit may be utilized in such superconducting quantum computers known as “transmons.” Transmons are a special type of qubit with a shunted capacitor specifically designed to mitigate noise. The transmon qubit model is based on the Cooper pair box with an increased ratio of Josephson to charge energy to mitigates noise.

In superconducting quantum computers, such transmon qubits are controlled via the use of microwave radio frequency signals. That is, such transmon qubits can be manipulated by microwave radio frequency signals. The states of such transmon qubits are then read, such as via the use of a microwave resonator, where the resonance frequency of the resonator is dispersively shifted by the qubit state.

As the number of qubits increases, the range of useful frequencies becomes crowded and noisy and effective computation diminishes. In particular, it becomes difficult to discern between transmon qubit states, especially using dynamic circuits in kernel threshold systems.

Dynamic circuits are quantum circuits that contain mid-circuit measurements that affect the control flow of gate execution later in the circuit, otherwise known as feed-forward operations. The canonical and most simple example is conditional reset, where a projective measurement of the qubit is performed. If the result is a |1 [symbol] , the state is flipped using an X-gate from the |1 [symbol] state to the |0 [symbol] state. If the result is a |0 [symbol] , the state is not flipped.

Dynamic circuits utilize a low latency decision architecture known as “kernels” that makes evaluations based on the state read from the qubit. A “kernel” refers to a time domain filter calibrated to a specific task. A real-time convolution of incoming signals (e.g., microwave radio frequency signals) with the kernel is then performed generating an integrated result (also referred to as the “kernel response”) which is compared to a threshold to determine the quantum state of the qubit (e.g., transom qubit). For example, if the integrated result exceeds a threshold, then the result may be deemed to be a 1; whereas, if the integrated result is less than the threshold, then the result may be deemed to a 0.

If calculations for such dynamic circuits expand to other states, besides the |0 [symbol] and |1 [symbol] state, such as the |2 [symbol] and |3 [symbol] states, it becomes difficult to keep the calculation low in latency, which is necessary in order to enable proper operation. As a result, fast decision-making kernels are applied in real time against sampled data. Such an output is compared against a set of thresholds to determine the state readout.

Unfortunately, with kernel threshold systems, the sample size of the kernel needs to be large enough in order to clearly distinguish the state of the input. For example, the sample size may range from thousands to tens of thousands of samples or even more. In latency sensitive applications, such a large sample size can result in a long capture window thereby slowing the dynamic circuit's ability to respond.

Furthermore, kernel threshold systems are often sensitive to in-band noise (e.g., cross-talk, Nyquist folding, etc.). Cross-talk is the disturbance caused by the electric or magnetic fields of a signal affecting an adjacent signal. Nyquist folding refers to the noise and signal images folded from upper Nyquist zones into the first Nyquist zone. As a result of such in-band noise, more samples are required thereby further increasing the capture window and further slowing the dynamic circuit's ability to respond. Furthermore, such noise may result in difficulty in discerning between the qubit states (e.g., transmon qubit states).

Additionally, in multiplexed applications, bleed over energy (energy spreading across adjacent channels) may also cause issues with dynamic decision making in a similar manner as cross-talk, including difficulty in discerning between the qubit states (e.g., transmon qubit states).

As a result, there is great interest in solutions which address the difficultly of discerning qubit states (e.g., transmon qubit states) in superconducting quantum computers, especially those using dynamic circuits in kernel threshold systems.

### SUMMARY

In one embodiment of the present disclosure, a method for improving discernment between qubit states in superconducting quantum computers comprises shifting a phase of a signal in response to a kernel response not meeting criteria. The method further comprises using the phase shifted signal to measure a state of a first qubit in response to the kernel response meeting the criteria using the phase shifted signal.

Additionally, in one embodiment of the present disclosure, the method further comprises continuing to adjust the phase of the phase shifted signal until the kernel response meets the criteria.

Furthermore, in one embodiment of the present disclosure, the method additionally comprises calibrating each of a plurality of channels used for communicating a measured state of qubits.

Additionally, in one embodiment of the present disclosure, the method further comprises reading a plurality of responses of a second qubit set to a first quantum state for a first channel of the plurality of channels as a result of a dynamic circuit performing quantum operations on the second qubit set to the first quantum state. The method additionally comprises reading a plurality of responses of the second qubit set to a second quantum state for the first channel of the plurality of channels as a result of the dynamic circuit performing quantum operations on the second qubit set to the second quantum state.

Furthermore, in one embodiment of the present disclosure, the method additionally comprises generating and recording kernel states with respect to the first quantum state and the second quantum state based on the read responses of the second qubit set to the first quantum state and the second quantum state in response to the first channel completing calibration, where kernel responses are obtained from the calibrated first channel using the kernel states.

Additionally, in one embodiment of the present disclosure, the method comprises setting an excitation state of a third qubit to a quantum state. The method further comprises reading a response of the third qubit as result of the dynamic circuit performing quantum operations on the third qubit set to the quantum state. Furthermore, the method comprises determining a kernel response of the third qubit based on the read response of the third qubit and the kernel states. Additionally, the method comprises comparing the kernel response of the third qubit with the kernel responses obtained from the calibrated first channel. In addition, the method comprises shifting the phase of the signal of the calibrated first channel in response to a difference between the kernel response of the third qubit and the kernel responses obtained from the calibrated first channel exceeding a threshold value.

Furthermore, in one embodiment of the present disclosure, the method comprises recalibrating the first channel using the phase shifted signal.

Other forms of the embodiments of the method described above are in a system and in a computer program product.

Accordingly, embodiments of the present disclosure improve the discernment between qubit states in superconducting quantum computers by shifting the phases of the signals used to measure the state of the qubits thereby ablating the effects of noise when discerning the qubit states and increasing the speed and accuracy of state discernment.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates the kernel response in terms of a range of calculations for the readout threshold with respect to the frequency and phase of the signal in accordance with an embodiment of the present disclosure;

FIG. 3 is a diagram of the software components of the classical computer used for improving the discernment between qubit states in superconducting quantum computers by shifting the phases of the signals used to measure the state of the qubits which ablates the effects of noise when discerning the qubit states in accordance with an embodiment of the present disclosure;

FIG. 4 illustrates the architecture for improving discernment between qubit states in superconducting quantum computers by shifting the phases of the signals used to measure the state of the qubits which ablates the effect of noise when discerning the qubit states in accordance with an embodiment of the present disclosure;

FIG. 5 illustrates calibrating the channels by the calibration engine in accordance with an embodiment of the present disclosure;

FIG. 6 illustrates determining if the kernel response is affected by performing quantum operations on the qubits at the same time in adjacent channels in response to the completion of the calibration of a new channel in accordance with an embodiment of the present disclosure;

FIG. 7 illustrates an embodiment of the present disclosure of the hardware configuration of the classical computer which is representative of a hardware environment for practicing the present disclosure;

FIG. 8 is a flowchart of a method for calibrating a channel to train the kernel to have the correct calibration data in accordance with an embodiment of the present disclosure; and

FIG. 9 is a flowchart of a method for improving discernment between quantum states in superconducting quantum computers in accordance with an embodiment of the present disclosure.

### DETAILED DESCRIPTION

As stated in the Background section, in superconducting quantum computers, qubits, such as transmon qubits, are controlled via the use of microwave radio frequency signals. That is, such transmon qubits can be manipulated by microwave radio frequency signals. The states of such transmon qubits are then read, such as via the use of a microwave resonator, where the resonance frequency of the resonator is dispersively shifted by the qubit state.

As the number of qubits increases, the range of useful frequencies becomes crowded and noisy and effective computation diminishes. In particular, it becomes difficult to discern between transmon qubit states, especially using dynamic circuits in kernel threshold systems.

Dynamic circuits are quantum circuits that contain mid-circuit measurements that affect the control flow of gate execution later in the circuit, otherwise known as feed-forward operations. The canonical and most simple example is conditional reset, where a projective measurement of the qubit is performed. If the result is a |1 [symbol] , the state is flipped using an X-gate from the |1 [symbol] state to the |0 [symbol] state. If the result is a |0 [symbol] , the state is not flipped.

Dynamic circuits utilize a low latency decision architecture known as “kernels” that makes evaluations based on the state read from the qubit. A “kernel” refers to a time domain filter calibrated to a specific task. A real-time convolution of incoming signals (e.g., microwave radio frequency signals) with the kernel is then performed generating an integrated result (also referred to as the “kernel response”) which is compared to a threshold to determine the quantum state of the qubit (e.g., transom qubit). For example, if the integrated result exceeds a threshold, then the result may be deemed to be a 1; whereas, if the integrated result is less than the threshold, then the result may be deemed to a 0.

If calculations for such dynamic circuits expand to other states, besides the |0 [symbol] and |1 [symbol] state, such as the |2 [symbol] and |3 [symbol] states, it becomes difficult to keep the calculation low in latency, which is necessary in order to enable proper operation. As a result, fast decision-making kernels are applied in real time against sampled data. Such an output is compared against a set of thresholds to determine the state readout.

Unfortunately, with kernel threshold systems, the sample size of the kernel needs to be large enough in order to clearly distinguish the state of the input. For example, the sample size may range from thousands to tens of thousands of samples or even more. In latency sensitive applications, such a large sample size can result in a long capture window thereby slowing the dynamic circuit's ability to respond.

Furthermore, kernel threshold systems are often sensitive to in-band noise (e.g., cross-talk, Nyquist folding, etc.). Cross-talk is the disturbance caused by the electric or magnetic fields of a signal affecting an adjacent signal. Nyquist folding refers to the noise and signal images folded from upper Nyquist zones into the first Nyquist zone. As a result of such in-band noise, more samples are required thereby further increasing the capture window and further slowing the dynamic circuit's ability to respond. Furthermore, such noise may result in difficulty in discerning between the qubit states (e.g., transmon qubit states).

Additionally, in multiplexed applications, bleed over energy (energy spreading across adjacent channels) may also cause issues with dynamic decision making in a similar manner as cross-talk, including difficulty in discerning between the qubit states (e.g., transmon qubit states).

As a result, there is great interest in solutions which address the difficultly of discerning qubit states (e.g., transmon qubit states) in superconducting quantum computers, especially those using dynamic circuits in kernel threshold systems.

The embodiments of the present disclosure provide the means for improving the discernment between qubit states in superconducting quantum computers by shifting the phases of the signals used to measure the state of the qubits thereby ablating the effects of noise when discerning the qubit states and increasing the speed and accuracy of state discernment as discussed in further detail below.

In some embodiments of the present disclosure, the present disclosure comprises a method, system and computer program product for improving discernment between qubit states in superconducting quantum computers. In one embodiment of the present disclosure, channels (qubit readout channels) are calibrated to train the kernel to contain the correct calibration data which is used with the readout signal to obtain the kernel response calculations. After calibrating a channel, testing is performed in which quantum operations are performed on qubits at the same time in adjacent channels, including the recently calibrated channel, to determine if the kernel response differs from the expected kernel response. If such a situation occurs, then the phase of the signal for the recently calibrated channel is shifted and the process of recalibrating the channel (using the phase shifted signal) and testing is repeated until the difference between the kernel response and the expected kernel response is not beyond the threshold value. When such a situation occurs, the range of calculations for the kernel response is closest to the resonance point (point at which the frequency of the signal matches the natural frequency of the system) which effectively ablates the effects of noise when discerning the qubit states and increases the speed and accuracy of state discernment.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

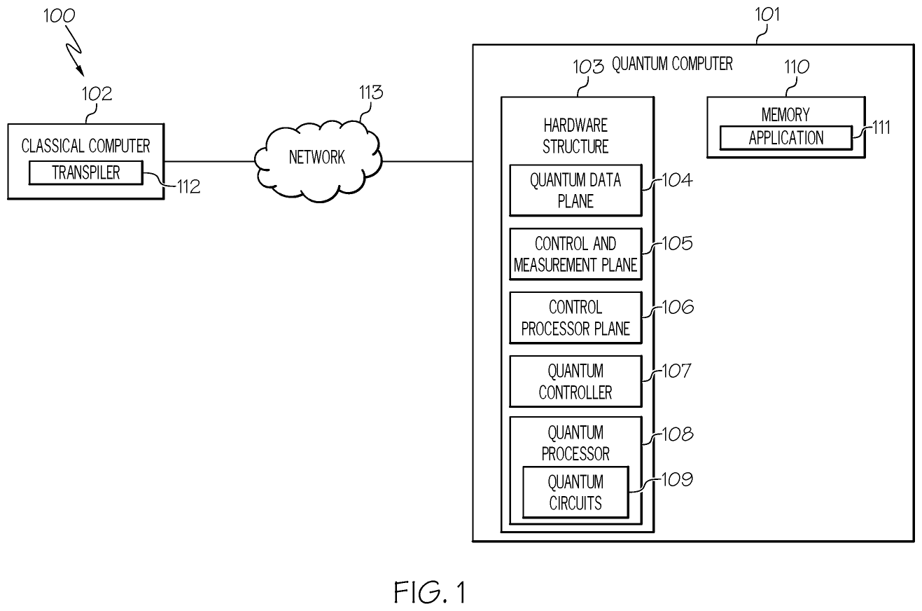

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to setup the state of quantum bits in quantum computer 101 and then quantum computer 101 starts the quantum process. Furthermore, in one embodiment, classical computer 102 is configured to improve discernment between qubit states in superconducting quantum computers by shifting the phases of the signals used to measure the state of the qubits thereby ablating the effects of noise when discerning the qubit states as discussed further below.

In one embodiment, a hardware structure 103 of quantum computer 101 includes a quantum data plane 104, a control and measurement plane 105, a control processor plane 106, a quantum controller 107 and a quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state and both “on” and “off”' states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. In one embodiment, quantum circuit 109 is a dynamic circuit. A “dynamic circuit,” as used herein, is a quantum circuit that contains mid-circuit measurements that affect the control flow of gate execution later in the circuit, otherwise known as feed-forward operations. Dynamic circuits utilize a low latency decision architecture known as “kernels” that makes evaluations based on the state read from the qubit. If calculations for such dynamic circuits expand to other states, besides the |0 [symbol] and |1 [symbol] state, such as the |2 [symbol] and |3 [symbol] states, it becomes difficult to keep the calculation low in latency, which is necessary in order to enable proper operation. As a result, fast decision-making kernels are applied in real time against sampled data. Such an output is compared against a set of thresholds to determine the state readout.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

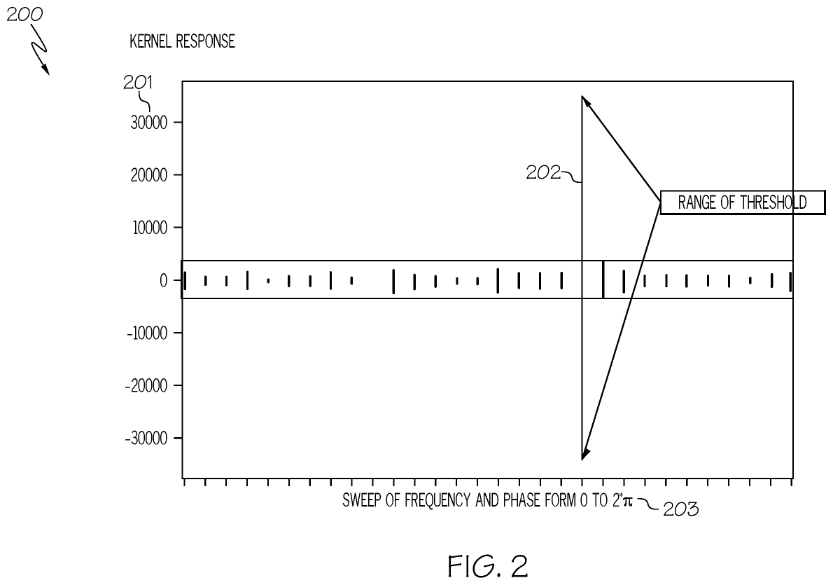

In one embodiment, memory 110 stores an application 111 that may be configured to implement one or more of the methods described herein in accordance with one or more embodiments. For example, application 111 may implement a program for improving discernment between qubit states in superconducting quantum computers by shifting the phases of the signals used to measure the state of the qubits thereby ablating the effects of noise when discerning the qubit states as discussed further below in connection with FIGS. 2-9. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses and algorithms) converts the trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to setup the state of quantum bits in quantum computer 101, may be connected to quantum computer 101 via a network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

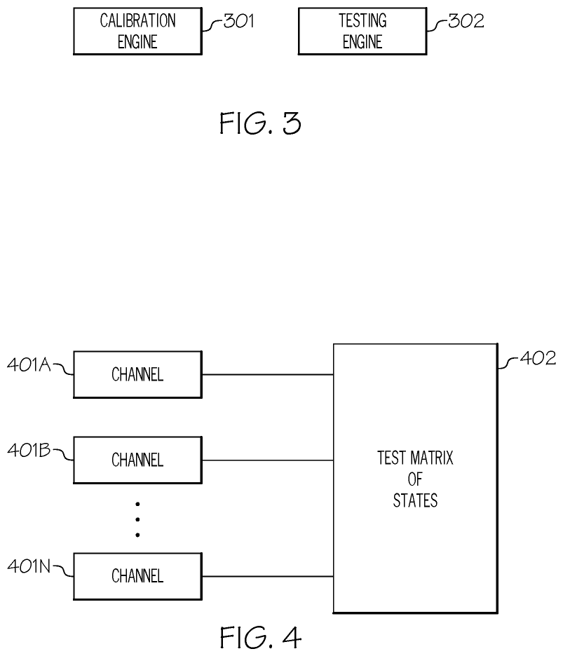

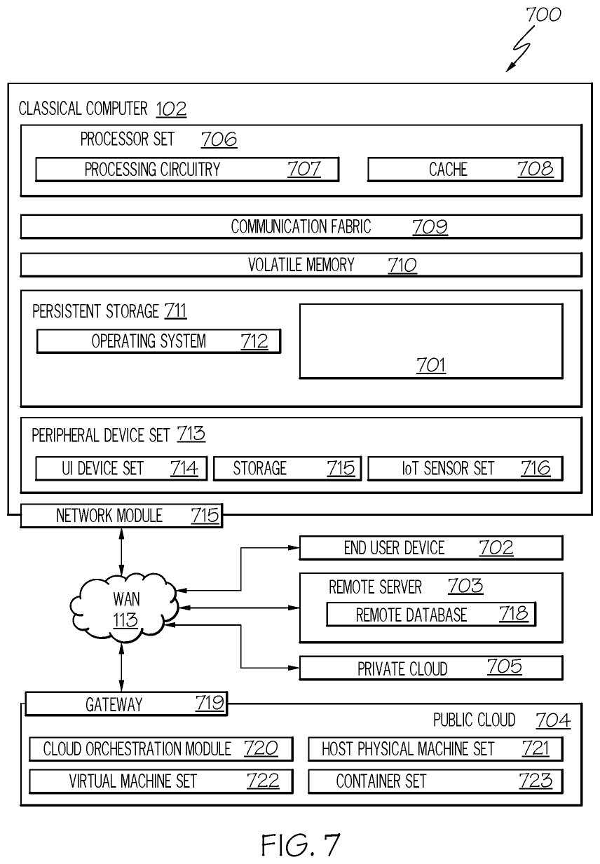

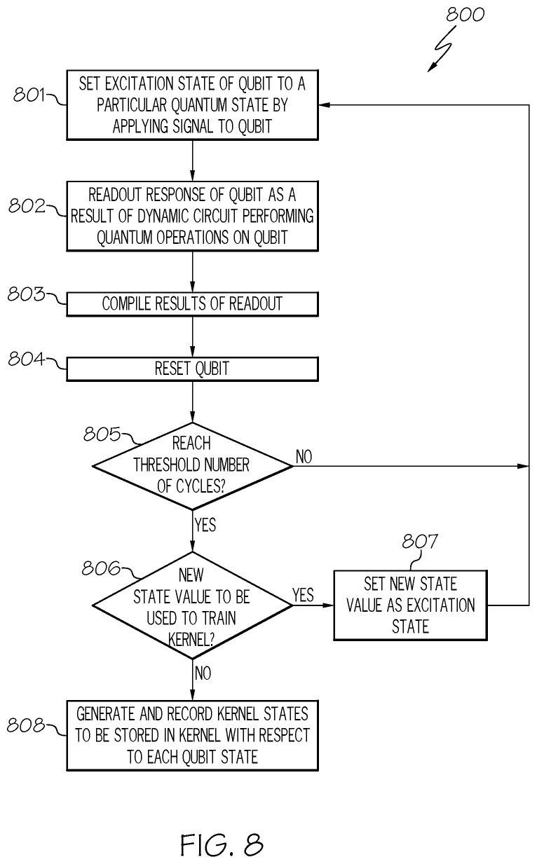

Furthermore, classical computer 102 is configured to improve discernment between qubit states in superconducting quantum computers by shifting the phases of the signals used to measure the state of the qubits thereby ablating the effects of noise when discerning the qubit states as discussed further below in connection with FIGS. 2-9. A description of the software components of classical computer 102 is provided below in connection with FIG. 3 and a description of the hardware configuration of classical computer 102 is provided further below in connection with FIG. 7.

System 100 is not to be limited in scope to any one particular network architecture. System 100 may include any number of quantum computers 101, classical computers 102 and networks 113.

A brief discussion regarding changing the influence on the threshold is now deemed appropriate.

As previously discussed, fast decision-making kernels of dynamic circuits are applied in real time against sampled data. Such an output (also referred to as an “integrated result” or the “kernel response”) is compared against a set of thresholds to determine the state readout. Unfortunately, with kernel threshold systems, the sample size of the kernel needs to be large enough in order to clearly distinguish the state of the input. Furthermore, such kernel threshold systems are often sensitive to in-band noise, such as cross-talk or multiplexing.

It has been discovered that the kernel response from a signal (e.g., microwave radio frequency (RF) signals) has a larger threshold the closer to the resonance point (point at which the frequency of the signal matches the natural frequency of the system). An illustration of an exemplary kernel response based on a range of frequency and phase from 0 to 2*π is provided in FIG. 2.

Referring to FIG. 2, FIG. 2 illustrates the kernel response 200 in terms of a range of calculations (“kernel response calculations” or the “integrated result calculations”) shown along the y-axis 201 (indicated by the length of the vertical bars, such as bar 202) for the readout threshold with respect to the frequency and phase of the signal (microwave RF signal used to measure the qubits) shown along the x-axis 203 in accordance with an embodiment of the present disclosure.

As illustrated in FIG. 2, the range of kernel response calculations for the readout threshold, such as shown in bar 202, is larger the closer to the resonance point (point at which the frequency of the signal matches the natural frequency of the system).

Furthermore, shifting the phase of either the victim or aggressor changes the influence on the threshold. The “aggressor,” as used herein, refers to the source of the noise; whereas, the “victim” refers to the signal impacted from the noise of the aggressor. By phase shifting the aggressor or victim signal, the kernel response 200 may result in a larger range of calculations (kernel response calculations or integrated result calculations) for the readout threshold, especially close to the resonance point.

As a result, the principles of the present disclosure are directed to addressing such in-band noise, such as cross-talk or multiplexing, by shifting the phase of the signals used to measure the qubits so that the kernel response is close to the resonance point thereby ablating the effects of noise when discerning the qubit states as discussed below in connection with FIG. 3.

FIG. 3 is a diagram of the software components of classical computer 102 (FIG. 1) used for improving the discernment between qubit states in superconducting quantum computers by shifting the phases of the signals used to measure the state of the qubits which ablates the effects of noise when discerning the qubit states in accordance with an embodiment of the present disclosure.

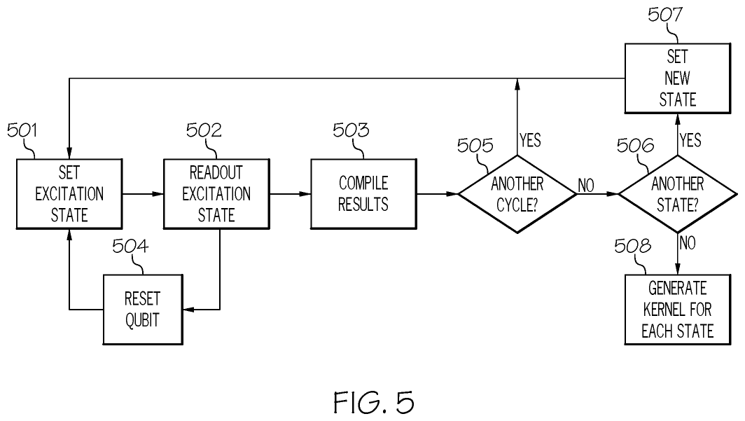

Referring to FIG. 3, in conjunction with FIG. 1, classical computer 102 includes a calibration engine 301 configured to calibrate channels (“qubit readout channels”) which are used for communicating the measured state of the qubits. A “channel,” as used herein, refers to a radio frequency channel which communicates the measured state of the qubits. An example of such channels is discussed below in connection with FIGS. 4 and 5.

FIG. 4 illustrates the architecture for improving discernment between qubit states in superconducting quantum computers by shifting the phases of the signals used to measure the state of the qubits which ablates the effect of noise when discerning the qubit states in accordance with an embodiment of the present disclosure. As shown in FIG. 4, such an architecture includes channels 401A-401N, where N is a positive integer number, connected to a test matrix of states 402. Channels 401A-401N may collectively or individually be referred to as channels 401 or channel 401, respectively.

As discussed above, channel 401 is used for reading out the states of the qubits. Furthermore, in one embodiment, channel 401 is calibrated to train the kernel to have the correct calibration data which is used with the readout signal to obtain the kernel response calculations, which when compared with a threshold determines the qubit state. In one embodiment, the calibration of channels 401 involves setting the excitation state of the qubit to a particular state (e.g., qubit state of 1) and then reading the response of the qubit for that state for a user-designated number of iterations, which are used to calibrate the kernel for that particular state. Such a process is performed for each of the qubit states. Such kernel response calculations are utilized to determine if a channel 401 is being affected by in-band noise using the test matrix of states 402 as discussed further below. A further discussion regarding calibrating channels 401 is provided below in connection with FIG. 5.

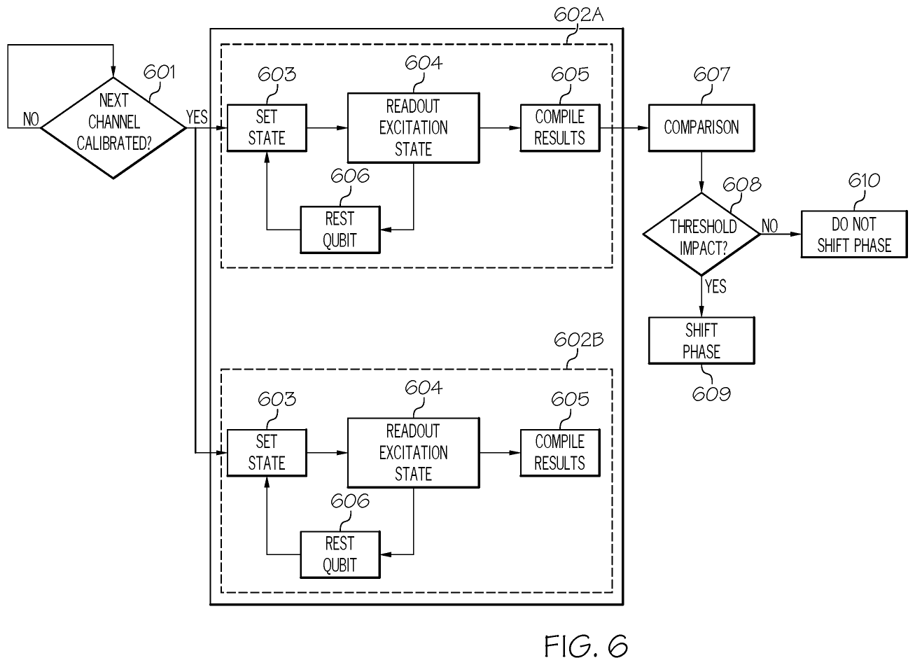

In one embodiment, test matrix of states 402 is configured to utilize the trained kernel with respect to the qubit states for each calibrated channel 401 to determine (“test”) if the kernel response calculations are affected by performing quantum operations on the qubits at the same time in adjacent channels 401, such as the channel 401 (e.g., channel 401A) that has recently been calibrated and a previously calibrated channel 401 (e.g., channel 401B). Since the trained kernel includes the correct kernel state calculations, the correct kernel response calculations are known that result in correctly determining the quantum state of the qubit. Such kernel response calculations can then be compared with the kernel response calculations obtained from test matrix of states 402. If the difference between such kernel response calculations exceeds a threshold value, which may be user-designated, then it may be inferred that such a difference is due to in-band noise. In an attempt to ablate the effects of such noise when discerning the qubit states and increasing the speed and accuracy of state discernment, the phase of the signal for the calibrated channel 401 (e.g., channel 401A) is shifted in response to the range of calculations of a readout threshold (i.e., the kernel response calculations) not meeting such criteria. “Criteria,” as used herein, refers to the difference between kernel response calculations being less than a threshold value, which may be user-specified. After phase shifting the signal for channel 401 that was recently calibrated, the process of calibrating such a channel 401 to train the kernel is repeated using the phase shifted signal followed by utilizing the trained kernel to determine (“test”) if the phase of the phase shift signal needs to be further adjusted by test matrix of states 402. A further discussion of testing by test matrix of states 402 is provided below in connection with FIG. 6.

Referring now to FIG. 5, FIG. 5 illustrates calibrating channels 401 by calibration engine 301 in accordance with an embodiment of the present disclosure. In particular, FIG. 5 illustrates the procedural flow of calibration of the kernel based on channel 401. As shown in FIG. 5, calibration engine 301 sets the excitation state of the qubit (e.g., transmon qubit) to a particular state (higher energy than the ground state) (see element 501), such as by applying a signal (e.g., RF signal) to the qubit. An excited state is any quantum state (e.g., |1 [symbol] , |2 [symbol] ) that has a higher energy than the ground state, |0 [symbol] . In one embodiment, the setpoint for each state is known from previous calibrations.

Calibration engine 301 is further configured to read out the response of the qubit as a result of the dynamic circuit performing quantum operations on the qubit (see element 502). That is, calibration engine 301 reads out the response of the qubit set to a particular qubit state (e.g., qubit state of). In one embodiment, such measurements are compiled (see element 503) and stored, such as in a data structure stored in a storage device of classical computer 102. As discussed below, such measurements are used to obtain the kernel state calculations of the kernel for the particular qubit state in question.

Furthermore, in one embodiment, calibration engine 301 resets the qubit (see element 504) by setting the qubit to the ground state to be ready to have its excitation state set in the next cycle.

Furthermore, in one embodiment, after each read out of the response of the qubit, calibration engine 301 determines whether a threshold number of readouts (threshold number of cycles) have been performed after setting the excitation state of the qubit to a particular state (e.g., state of) (see element 505). In one embodiment, such a threshold number of cycles is user-designated.

If the threshold number of cycles has not been reached, then another iteration of reading out the response of the qubit as a result of the dynamic circuit performing quantum operations on the qubit set to the same quantum state (e.g., quantum state of) is performed as discussed above. That is, the qubit is excited to the same excitation state as in the prior excitation. Such a process is repeated for at least N cycles, where N is a positive integer number which may be user-designated. That is, the process of exciting the qubit, reading or measuring the response of the qubit and resetting the qubit is performed for N cycles for a particular qubit state.

If, however, the threshold number of cycles has been reached, then calibration engine 301 determines whether there is a new state (quantum state) that has not been used to train the kernel (see element 506). That is, calibration engine 301 determines if the kernel has been trained to obtain the kernel state calculations for such a quantum state (e.g., quantum state of).

If there is a new state to be used to train the kernel, then calibration engine 301 sets the new state value as the excitation state of the qubit (see elements 507 and 501) and the process involving elements 501-504 is repeated as discussed above.

If, however, there are no new states to be used to train the kernel, then calibration engine 301 generates the “kernel state calculations” to be stored in the kernel with respect to each qubit state (e.g., qubit state of

In one embodiment, such kernel state calculations correspond to the readout responses (see element 502) of the qubit set to a particular state (e.g., qubit state of) as previously discussed. Hence, calibration engine 301 generates the kernel state calculations to be stored in the kernel with respect to each qubit state (e.g., qubit state of based on such readout responses.

As previously discussed, the kernel response calculation (“integrated response calculation”) is compared to a threshold to determine the quantum state of the qubit. Since the qubit state is known when calibrating channel 401, such kernel state calculations can be derived using the procedure discussed above. Hence, the kernel response calculations (“integrated response calculations”) that should be obtained in order to correctly measure the state of the qubit are also known based on the training of the kernel discussed above.

In one embodiment, classical computer 102 includes a testing engine 302 configured to use these kernel state calculations of the kernel to determine if in-band noise is affecting the discernment of the quantum states by performing quantum operations on the qubits at the same time in adjacent channels 401 in response to a completion of the calibration of a new channel 401 as discussed below in connection with FIG. 6.

FIG. 6 illustrates determining if the kernel response is affected by performing quantum operations on the qubits at the same time in adjacent channels 401 in response to the completion of the calibration of a new channel 401 in accordance with an embodiment of the present disclosure.

As shown in FIG. 6, testing engine 302 determines whether a new quantum channel 401 has finished calibration (see element 601). If a new quantum channel 401 has not finished calibration, then testing engine 302 continues to determine whether a new quantum channel 401 has finished calibration. If, however, a new quantum channel 401 has finished calibration, then testing is performed, which is discussed below.

In one embodiment, testing engine 302 reads out the response of the qubit set to a particular qubit state (e.g., qubit state of) for the recently calibrated channel 401 (e.g., channel 401A) at the same time testing engine 302 reads out the response of the qubit set to a particular qubit state (e.g., qubit state of) in an adjacent channel 401 (e.g., channel 401B). In this manner, the principles of the present disclosure determine whether in-band noise affects the kernel response calculations, which affects the discernment of the quantum state, as discussed below.

In one embodiment, testing engine 302 sets the state of the qubits in adjacent channels (e.g., channels 401A, 401B) that have completed calibration, including one of the channels having just recently completed calibration (e.g., channel 401A). For example, for qubits “Q0” and “Q1” with two states, such qubits may be set with the following state values: |00, |01, |10, |11, where qubit Q0 may be set to the value of for channel 401 (e.g., channel 401A) that was recently calibrated and qubit Q1 may be set to the value of for channel 401 (e.g., channel 401B) that was previously calibrated. Testing engine 302 may then perform the readout of the response to such qubits for such channels 401 as illustrated in units 602A-602B, where unit 602A corresponds to performing the readout of the response to the qubit for channel 401 (e.g., channel 401A) that recently completed calibration and where unit 602B corresponds to performing the readout of the response to the qubit for channel 401 (e.g., channel 401B) that previously completed calibration. Units 602A-602B may collectively or individually be referred to as units 602 or unit 602, respectively.

Referring to unit 602 of FIG. 6, testing engine 302 sets the excitation state of the qubit (e.g., transmon qubit) to a particular state (e.g., qubit state of) (see element 603), such as by applying a signal (e.g., RF signal) to the qubit.

Testing engine 302 is further configured to read out the response of the qubit as a result of the dynamic circuit performing quantum operations on the qubit (see element 604). That is, testing engine 302 reads out the response of the qubit set to a particular qubit state in each of the channels 401. In one embodiment, such a measurement is compiled (see element 605) and stored, such as in a data structure stored in a storage device of classical computer 102.

Furthermore, in one embodiment, testing engine 302 resets the qubit (see element 606) by setting the qubit to the ground state to be ready to have its excitation state set in a following test.

In one embodiment, testing engine 302 determines the kernel response calculation involving the recently calibrated channel 401 (e.g., channel 401A). Such a kernel response calculation is then compared (see element 607) with the kernel response calculations obtained from the calibrated channel 401 (e.g., channel 401A) discussed above. Such a comparison is performed to determine if there is a threshold impact (see element 608). That is, such a comparison is performed to determine if the difference between such kernel response calculations exceeds a threshold value. In other words, the comparison is performed to determine whether the kernel response meets or does not meet the criteria, which may be user-specified. “Criteria,” as used herein, refers to the difference between kernel response calculations being less than a threshold value, which may be user-specified.

If the difference exceeds a threshold value (i.e., there is a threshold impact), then the phase of the signal of the recently calibrated channel 401 (e.g., channel 401A) is shifted (see element 609). Channel 401 (e.g., channel 401A) that completed calibration is then recalibrated using the phase shifted signal as discussed above.

If, however, the difference does not exceed a threshold value (i.e., there is not a threshold impact), then the phase of the signal of the recently calibrated channel 401 (e.g., channel 401A) is not shifted or adjusted (i.e., do not adjust the phase of the signal that was previously shifted in a prior iteration) (see element 610). The signal, including a previously phase-shifted signal, may then be used to measure the state of the qubit.

The above-described process continues until the phase shift of the signal achieves the desired result (i.e., the difference between the kernel response calculations does not exceed the threshold value). If such a desired result cannot be achieved, an error is reported, such as to the user of classical computer 102.

A further discussion regarding these and other features is provided below in connection with the discussion of the method for improving discernment between qubit states.

Prior to the discussion of the method for improving discernment between qubit states, a description of the hardware configuration of classical computer 102 (FIG. 1) is provided below in connection with FIG. 7.

Referring now to FIG. 7, in conjunction with FIG. 1, FIG. 7 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code (stored in block 701) involved in performing the inventive methods, such as improving discernment between qubit states. In addition to block 701, computing environment 700 includes, for example, classical computer 102, network 113, such as a wide area network (WAN), end user device (EUD) 702, remote server 703, public cloud 704, and private cloud 705. In this embodiment, classical computer 102 includes processor set 706 (including processing circuitry 707 and cache 708), communication fabric 709, volatile memory 710, persistent storage 711 (including operating system 712 and block 701, as identified above), peripheral device set 713 (including user interface (UI) device set 714, storage 715, and Internet of Things (IoT) sensor set 716), and network module 717. Remote server 703 includes remote database 718. Public cloud 704 includes gateway 719, cloud orchestration module 720, host physical machine set 721, virtual machine set 722, and container set 723.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 718. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically classical computer 102, to keep the presentation as simple as possible. Classical computer 102 may be located in a cloud, even though it is not shown in a cloud in FIG. 7. On the other hand, classical computer 102 is not required to be in a cloud except to any extent as may be affirmatively indicated.

Processor set 706 includes one, or more, computer processors of any type now known or to be developed in the future. Processing circuitry 707 may be distributed over multiple packages, for example, multiple, coordinated integrated circuit chips. Processing circuitry 707 may implement multiple processor threads and/or multiple processor cores. Cache 708 is memory that is located in the processor chip package(s) and is typically used for data or code that should be available for rapid access by the threads or cores running on processor set 706. Cache memories are typically organized into multiple levels depending upon relative proximity to the processing circuitry. Alternatively, some, or all, of the cache for the processor set may be located “off chip.” In some computing environments, processor set 706 may be designed for working with qubits and performing quantum computing.

Computer readable program instructions are typically loaded onto classical computer 102 to cause a series of operational steps to be performed by processor set 706 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 708 and the other storage media discussed below. The program instructions, and associated data, are accessed by processor set 706 to control and direct performance of the inventive methods. In computing environment 700, at least some of the instructions for performing the inventive methods may be stored in block 701 in persistent storage 711.

Communication fabric 709 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 710 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 710 is located in a single package and is internal to classical computer 102, but, alternatively or additionally, the volatile memory may be distributed over multiple packages and/or located externally with respect to classical computer 102.

Persistent Storage 711 is any form of non-volatile storage for computers that is now known or to be developed in the future. The non-volatility of this storage means that the stored data is maintained regardless of whether power is being supplied to classical computer 102 and/or directly to persistent storage 711. Persistent storage 711 may be a read only memory (ROM), but typically at least a portion of the persistent storage allows writing of data, deletion of data and re-writing of data. Some familiar forms of persistent storage include magnetic disks and solid-state storage devices. Operating system 712 may take several forms, such as various known proprietary operating systems or open source Portable Operating System Interface type operating systems that employ a kernel. The code included in block 701 typically includes at least some of the computer code involved in performing the inventive methods.

Peripheral device set 713 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 714 may include components such as a display screen, speaker, microphone, wearable devices (such as goggles and smart watches), keyboard, mouse, printer, touchpad, game controllers, and haptic devices. Storage 715 is external storage, such as an external hard drive, or insertable storage, such as an SD card. Storage 715 may be persistent and/or volatile. In some embodiments, storage 715 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 716 is made up of sensors that can be used in Internet of Things applications. For example, one sensor may be a thermometer and another sensor may be a motion detector.

Network module 717 is the collection of computer software, hardware, and firmware that allows classical computer 102 to communicate with other computers through WAN 113. Network module 717 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 717 are performed on the same physical hardware device. In other embodiments (for example, embodiments that utilize software-defined networking (SDN)), the control functions and the forwarding functions of network module 717 are performed on physically separate devices, such that the control functions manage several different network hardware devices. Computer readable program instructions for performing the inventive methods can typically be downloaded to classical computer 102 from an external computer or external storage device through a network adapter card or network interface included in network module 717.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 702 is any computer system that is used and controlled by an end user (for example, a customer of an enterprise that operates classical computer 102), and may take any of the forms discussed above in connection with classical computer 102. EUD 702 typically receives helpful and useful data from the operations of classical computer 102. For example, in a hypothetical case where classical computer 102 is designed to provide a recommendation to an end user, this recommendation would typically be communicated from network module 717 of classical computer 102 through WAN 113 to EUD 702. In this way, EUD 702 can display, or otherwise present, the recommendation to an end user. In some embodiments, EUD 702 may be a client device, such as thin client, heavy client, mainframe computer, desktop computer and so on.

Remote server 703 is any computer system that serves at least some data and/or functionality to classical computer 102. Remote server 703 may be controlled and used by the same entity that operates classical computer 102. Remote server 703 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 718 of remote server 703.

Public cloud 704 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 704 is performed by the computer hardware and/or software of cloud orchestration module 720. The computing resources provided by public cloud 704 are typically implemented by virtual computing environments that run on various computers making up the computers of host physical machine set 721, which is the universe of physical computers in and/or available to public cloud 704. The virtual computing environments (VCEs) typically take the form of virtual machines from virtual machine set 722 and/or containers from container set 723. It is understood that these VCEs may be stored as images and may be transferred among and between the various physical machine hosts, either as images or after instantiation of the VCE. Cloud orchestration module 820 manages the transfer and storage of images, deploys new instantiations of VCEs and manages active instantiations of VCE deployments. Gateway 719 is the collection of computer software, hardware, and firmware that allows public cloud 704 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 705 is similar to public cloud 704, except that the computing resources are only available for use by a single enterprise. While private cloud 705 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 704 and private cloud 705 are both part of a larger hybrid cloud.

Block 701 further includes the software components discussed above in connection with FIGS. 3-6 to improve discernment between qubit states. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for improving discernment between qubit states, may be embodied in an application specific integrated circuit.

As stated above, in superconducting quantum computers, qubits, such as transmon qubits, are controlled via the use of microwave radio frequency signals. That is, such transmon qubits can be manipulated by microwave radio frequency signals. The states of such transmon qubits are then read, such as via the use of a microwave resonator, where the resonance frequency of the resonator is dispersively shifted by the qubit state. As the number of qubits increases, the range of useful frequencies becomes crowded and noisy and effective computation diminishes. In particular, it becomes difficult to discern between transmon qubit states, especially using dynamic circuits in kernel threshold systems. Dynamic circuits are quantum circuits that contain mid-circuit measurements that affect the control flow of gate execution later in the circuit, otherwise known as feed-forward operations. The canonical and most simple example is conditional reset, where a projective measurement of the qubit is performed. If the result is a |1 [symbol] , the state is flipped using an X-gate from the |1 [symbol] state to the |0 [symbol] state. If the result is a |0 [symbol] , the state is not flipped. Dynamic circuits utilize a low latency decision architecture known as “kernels” that makes evaluations based on the state read from the qubit. A “kernel” refers to a time domain filter calibrated to a specific task. A real-time convolution of incoming signals (e.g., microwave radio frequency signals) with the kernel is then performed generating an integrated result (also referred to as the “kernel response”) which is compared to a threshold to determine the quantum state of the qubit (e.g., transom qubit). For example, if the integrated result exceeds a threshold, then the result may be deemed to be a |1 [symbol] ; whereas, if the integrated result is less than the threshold, then the result may be deemed to a |0 [symbol] . If calculations for such dynamic circuits expand to other states, besides the |0 [symbol] and |1 [symbol] state, such as the |2 [symbol] and |3 [symbol] states, it becomes difficult to keep the calculation low in latency, which is necessary in order to enable proper operation. As a result, fast decision-making kernels are applied in real time against sampled data. Such an output is compared against a set of thresholds to determine the state readout. Unfortunately, with kernel threshold systems, the sample size of the kernel needs to be large enough in order to clearly distinguish the state of the input. For example, the sample size may range from thousands to tens of thousands of samples or even more. In latency sensitive applications, such a large sample size can result in a long capture window thereby slowing the dynamic circuit's ability to respond. Furthermore, kernel threshold systems are often sensitive to in-band noise (e.g., cross-talk, Nyquist folding, etc.). Cross-talk is the disturbance caused by the electric or magnetic fields of a signal affecting an adjacent signal. Nyquist folding refers to the noise and signal images folded from upper Nyquist zones into the first Nyquist zone. As a result of such in-band noise, more samples are required thereby further increasing the capture window and further slowing the dynamic circuit's ability to respond. Furthermore, such noise may result in difficulty in discerning between the qubit states (e.g., transmon qubit states). Additionally, in multiplexed applications, bleed over energy (energy spreading across adjacent channels) may also cause issues with dynamic decision making in a similar manner as cross-talk, including difficulty in discerning between the qubit states (e.g., transmon qubit states).

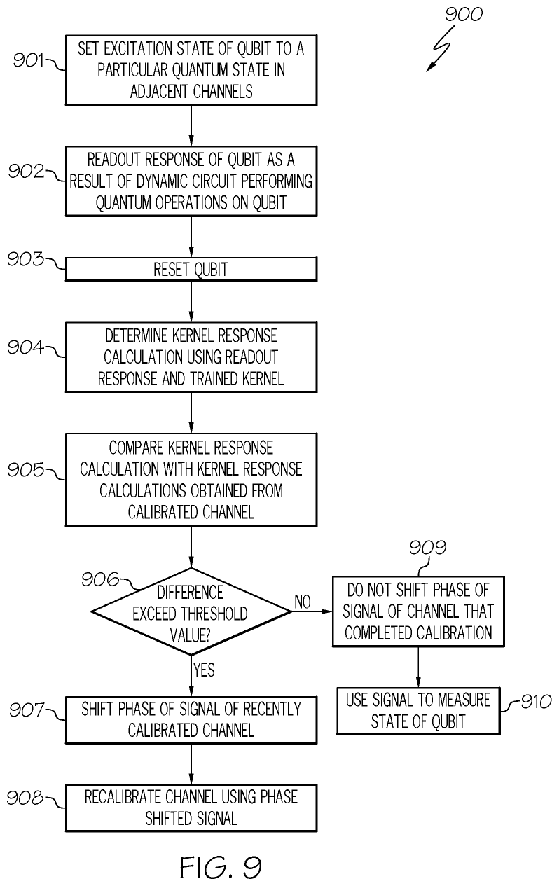

The embodiments of the present disclosure provide the means for discerning between qubit states in superconducting quantum computers, especially using dynamic circuits in kernel threshold systems, by shifting the phase of a signal in response to the kernel response not meeting criteria as discussed below in connection with FIGS. 8-9. FIG. 8 is a flowchart of a method for calibrating a channel to train the kernel to have the correct calibration data. FIG. 9 is a flowchart of a method for improving discernment between quantum states in superconducting quantum computers.

As discussed above, FIG. 8 is a flowchart of a method 800 for calibrating a channel 401 (FIGS. 4 and 5) to train the kernel to have the correct calibration data in accordance with an embodiment of the present disclosure.

Referring to FIG. 8, in conjunction with FIGS. 1-7, in step 801, calibration engine 301 sets the excitation state of a qubit (e.g., transmon qubit) to a particular quantum state (e.g., quantum state of) by applying a signal to the qubit for a channel 401 (e.g., channel 401A) to be calibrated.

As discussed above, calibration engine 301 sets the excitation state of the qubit to a particular state (higher energy than the ground state) (e.g., quantum state of), such as by applying a signal (e.g., RF signal) to the qubit. An excited state is any quantum state (e.g., |1 [symbol] , |2 [symbol] ) that has a higher energy than the ground state, |0 [symbol] . In one embodiment, the setpoint for each state is known from previous calibrations.

In step 802, calibration engine 301 reads out the response of the qubit set to a particular state (e.g., quantum state) as a result of the dynamic circuit performing quantum operations on the qubit.

In step 803, calibration engine 301 compiles the results of the readout (measurement).

As stated above, such a measurement is compiled and stored, such as in a data structure stored in a storage device (e.g., storage device 711, 715) of classical computer 102. As discussed below, such a measurement is used to obtain the kernel state calculations of the kernel for the particular qubit state in question.

In step 804, calibration engine 301 resets the qubit by setting the qubit to the ground state to be ready to have its excitation state set in the next cycle.

In step 805, calibration engine 301 determines if a threshold number of cycles, which may be user-designated, for reading out the response of the qubit set to a particular state (e.g., quantum state) has been reached. For example, in one embodiment, calibration engine 301 reads out the response of the qubit set to a particular state (e.g., quantum state of) for N cycles, where N is a positive integer number. As discussed below, calibration engine 301 performs such readouts of the qubit for each particular quantum state.

If the threshold number of cycles has not been reached, then calibration engine 301 sets the excitation state of the qubit to the same quantum state (e.g., quantum state of) for channel 401 (e.g., channel 401A) that is being calibrated in step 801 followed by reading out the response of the qubit in step 802. The process of steps 801-804 continues until a threshold number of cycles has been reached.

If the threshold number of cycles has been reached, then, in step 806, calibration engine 301 determines whether there is a new state (quantum state) that has not been used to train the kernel. That is, calibration engine 301 determines if the kernel has been trained to obtain the kernel state calculations for such a quantum state (e.g., quantum state of).

If there is a new quantum state to be used to train the kernel, then, in step 807, calibration engine 301 sets the new quantum state value (e.g., quantum state of) as the excitation state. Afterwards, calibration engine 301 sets the excitation state of the qubit (e.g., quantum state of) to the new quantum state value, such as by applying a signal (e.g., RF signal) to the qubit in step 801. The process of steps 801-804 then continues to be repeated for this quantum state (e.g., quantum state of) until a threshold number of cycles has been reached.

If, however, there are no new states to be used to train the kernel, then, in step 808, calibration engine 301 generates the kernel states to be stored in the kernel with respect to each qubit state (e.g., qubit state of, qubit state of) since the calibration of channel 401 is completed. In one embodiment, such kernel state calculations are recorded in a storage device (e.g., storage device 711,715) of classical computer 102.

As stated above, in one embodiment, such kernel state calculations correspond to the readout responses of the qubit in response to setting the qubit to a particular state (e.g., qubit state of) as previously discussed. Hence, calibration engine 301 generates the kernel state calculations to be stored in the kernel with respect to each qubit state (e.g., qubit state of) based on such readout responses.

As previously discussed, the kernel response calculation (“integrated response calculation”) is compared to a threshold to determine the quantum state of the qubit. Since the qubit state is known when calibrating channel 401, such kernel state calculations can be derived using the procedure discussed above. Hence, the kernel response calculations (“integrated response calculations”) that should be obtained in order to correctly measure the state of the qubit is also known based on the training of the kernel discussed above.

As discussed below, in conjunction with FIG. 9, such a trained kernel may be utilized to determine if the phase of a signal in the calibrated channel 401 (e.g., channel 401A) needs to be shifted in order to ablate the adverse effects of in-band noise and bleed over energy thereby improving the discernment between qubit states (e.g., transmon qubit states) in superconducting quantum computers.

FIG. 9 is a flowchart of a method 900 for improving discernment between quantum states in superconducting quantum computers in accordance with an embodiment of the present disclosure.

Referring to FIG. 9, in conjunction with FIGS. 1-8, in step 901, testing engine 302 sets the excitation state of the qubit (e.g., transom qubit) to a particular quantum state in adjacent channels (e.g., channels 401A, 401B) that have completed calibration, including the channel 401 (e.g., channel 401A) that recently completed calibration, as illustrated in units 602A-602B of FIG. 6. In one embodiment, testing engine 302 sets the excitation state of the qubit to a particular state (e.g., qubit state of), such as by applying a signal (e.g., RF signal) to the qubit.

For example, for qubits “Q0” and “Q1” with two states, such qubits may be set with the following state values: |00, |01, |10, |11, where qubit Q0 may be set to the value of | for channel 401 (e.g., channel 401A) that was recently calibrated and qubit Q1 may be set to the value of | for channel 401 (e.g., channel 401B) that was previously calibrated.

In step 902, testing engine 302 reads out the response to such qubits for such channels 401 as a result of the dynamic circuit performing quantum operations on the qubit as illustrated in units 602A-602B of FIG. 6, where unit 602A corresponds to performing the readout of the response of the qubit for channel 401 (e.g., channel 401A) that recently completed calibration and where unit 602B corresponds to performing the readout of the response of the qubit for channel 401 (e.g., channel 401B) that previously completed calibration. That is, testing engine 302 reads out the response of the qubit set to a particular qubit state in each of the channels 401 being tested. In one embodiment, such a measurement is compiled and stored, such as in a data structure stored in a storage device (e.g., storage device 711, 715) of classical computer 102.

In step 903, testing engine 302 resets the qubit in such channels (e.g., channels 401A, 401B) being tested by setting the qubit to the ground state to be ready to have its excitation state set in a following test as illustrated in units 602A-602B of FIG. 6.

In step 904, with respect to the channel 401 (e.g., channel 401A) that was recently calibrated, testing engine 302 determines the kernel response calculation using the readout response (see step 902) and the trained kernel (kernel state for channel 401 that was recently calibrated).

As discussed above, in one embodiment, testing engine 302 determines the kernel response calculation (obtained in step 902) with the trained kernel.

In step 905, testing engine 302 compares the kernel response calculation (obtained in step 904) with the kernel response calculations obtained from the calibrated channel 401 (e.g., channel 401A) discussed above.

In step 906, testing engine 302 determines if the difference between such kernel response calculations exceeds a threshold value, which may be user-designated.

As discussed above, such a comparison is performed to determine if there is a threshold impact. That is, such a comparison is performed to determine if the difference between such kernel response calculations exceeds a threshold value. In other words, the comparison is performed to determine whether the kernel response meets or does not meet the criteria, which may be user-specified. “Criteria,” as used herein, refers to the difference between kernel response calculations being less than a threshold value, which may be user-specified.

If the difference exceeds a threshold value (i.e., there is a threshold impact), then, in step 907, testing engine 301 shifts the phase of the signal of the recently calibrated channel 401 (e.g., channel 401A). In one embodiment, the amount of the shifting of the phase is a user-designated amount for each iteration. Such a shifting of the phase of the signal may involve adjusting the previously shifted phase if the phase of the signal was previously shifted.

In step 908, calibration engine 301 recalibrates channel 401 (e.g., channel 401A) that completed calibration using the phase shifted signal as discussed above.

If, however, the difference does not exceed a threshold value (i.e., there is not a threshold impact), then, in step 909, testing engine 302 does not shift or adjust (i.e., do not adjust the phase of the signal that was previously shifted in a prior iteration) the phase of the signal of channel 401 that completed calibration.

In step 910, the signal, including a previously phase-shifted signal, is used to measure the state of the qubit.

The above-described process continues until the phase shift of the signal achieves the desired result (i.e., the difference between the kernel response calculations is below a threshold value). If such a desired result cannot be achieved, an error is reported, such as to the user of classical computer 102.

In this manner, the discernment between qubit states in superconducting quantum computers is improved by shifting the phases of the signals used to measure the state of the qubits thereby ablating the effects of noise when discerning the qubit states and increasing the speed and accuracy of state discernment.

Furthermore, the principles of the present disclosure improve the technology or technical field involving superconducting quantum computing.

As discussed above, in superconducting quantum computers, qubits, such as transmon qubits, are controlled via the use of microwave radio frequency signals. That is, such transmon qubits can be manipulated by microwave radio frequency signals. The states of such transmon qubits are then read, such as via the use of a microwave resonator, where the resonance frequency of the resonator is dispersively shifted by the qubit state. As the number of qubits increases, the range of useful frequencies becomes crowded and noisy and effective computation diminishes. In particular, it becomes difficult to discern between transmon qubit states, especially using dynamic circuits in kernel threshold systems. Dynamic circuits are quantum circuits that contain mid-circuit measurements that affect the control flow of gate execution later in the circuit, otherwise known as feed-forward operations. The canonical and most simple example is conditional reset, where a projective measurement of the qubit is performed. If the result is a |1 [symbol] , the state is flipped using an X-gate from the |1 [symbol] state to the |0 [symbol] state. If the result is a |0 [symbol] , the state is not flipped. Dynamic circuits utilize a low latency decision architecture known as “kernels” that makes evaluations based on the state read from the qubit. A “kernel” refers to a time domain filter calibrated to a specific task. A real-time convolution of incoming signals (e.g., microwave radio frequency signals) with the kernel is then performed generating an integrated result (also referred to as the “kernel response”) which is compared to a threshold to determine the quantum state of the qubit (e.g., transom qubit). That is, the readout signal and the kernel generate an integrated result (“kernel response”) which is compared to a threshold to determine the quantum state of the qubit (e.g., transmon qubit). For example, if the integrated result exceeds a threshold, then the result may be deemed to be a 1; whereas, if the integrated result is less than the threshold, then the result may be deemed to a 0. If calculations for such dynamic circuits expand to other states, besides the |0 [symbol] and |1 [symbol] state, such as the |2 [symbol] and |3 [symbol] states, it becomes difficult to keep the calculation low in latency, which is necessary in order to enable proper operation. As a result, fast decision-making kernels are applied in real time against sampled data. Such an output is compared against a set of thresholds to determine the state readout. Unfortunately, with kernel threshold systems, the sample size of the kernel needs to be large enough in order to clearly distinguish the state of the input. For example, the sample size may range from thousands to tens of thousands of samples or even more. In latency sensitive applications, such a large sample size can result in a long capture window thereby slowing the dynamic circuit's ability to respond. Furthermore, kernel threshold systems are often sensitive to in-band noise (e.g., cross-talk, Nyquist folding, etc.). Cross-talk is the disturbance caused by the electric or magnetic fields of a signal affecting an adjacent signal. Nyquist folding refers to the noise and signal images folded from upper Nyquist zones into the first Nyquist zone. As a result of such in-band noise, more samples are required thereby further increasing the capture window and further slowing the dynamic circuit's ability to respond. Furthermore, such noise may result in difficulty in discerning between the qubit states (e.g., transmon qubit states). Additionally, in multiplexed applications, bleed over energy (energy spreading across adjacent channels) may also cause issues with dynamic decision making in a similar manner as cross-talk, including difficulty in discerning between the qubit states (e.g., transmon qubit states). As a result, there is great interest in solutions which address the difficultly of discerning qubit states (e.g., transmon qubit states) in superconducting quantum computers, especially those using dynamic circuits in kernel threshold systems.

Embodiments of the present disclosure improve such technology by calibrating channels (qubit readout channels) to train the kernel to contain the correct calibration data (also referred to herein as the “kernel states”) which is used with the readout signal to obtain the kernel response calculations. After calibrating a channel, testing is performed in which quantum operations are performed on qubits at the same time in adjacent channels, including the recently calibrated channel, to determine if the kernel response differs from the expected kernel response, where the expected kernel response is based on the kernel states of the trained kernel of the recently calibrated channel, beyond a threshold value. If such a situation occurs, then the phase of the signal for the recently calibrated channel is shifted and the process of recalibrating the channel (using the phase shifted signal) and testing is repeated until the difference between the kernel response and the expected kernel response is not beyond the threshold value. When such a situation occurs, the range of calculations for the kernel response is closest to the resonance point (point at which the frequency of the signal matches the natural frequency of the system) which effectively ablates the effects of noise when discerning the qubit states and increases the speed and accuracy of state discernment. Furthermore, in this manner, there is an improvement in the technical field involving superconducting quantum computing.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

In one embodiment of the present disclosure, a method for improving discernment between qubit states in superconducting quantum computers comprises shifting a phase of a signal in response to a kernel response not meeting criteria. The method further comprises using the phase shifted signal to measure a state of a first qubit in response to the kernel response meeting the criteria using the phase shifted signal.

Additionally, in one embodiment of the present disclosure, the method further comprises continuing to adjust the phase of the phase shifted signal until the kernel response meets the criteria.

Furthermore, in one embodiment of the present disclosure, the method additionally comprises calibrating each of a plurality of channels used for communicating a measured state of qubits.

Additionally, in one embodiment of the present disclosure, the method further comprises reading a plurality of responses of a second qubit set to a first quantum state for a first channel of the plurality of channels as a result of a dynamic circuit performing quantum operations on the second qubit set to the first quantum state. The method additionally comprises reading a plurality of responses of the second qubit set to a second quantum state for the first channel of the plurality of channels as a result of the dynamic circuit performing quantum operations on the second qubit set to the second quantum state.

Furthermore, in one embodiment of the present disclosure, the method additionally comprises generating and recording kernel states to be stored in a kernel with respect to the first quantum state and the second quantum state based on the read responses of the second qubit set to the first quantum state and the second quantum state in response to the first channel completing calibration, where kernel responses are obtained from the calibrated first channel using the kernel states.

Additionally, in one embodiment of the present disclosure, the method comprises setting an excitation state of a third qubit to a quantum state. The method further comprises reading a response of the third qubit as result of the dynamic circuit performing quantum operations on the third qubit set to the quantum state. Furthermore, the method comprises determining a kernel response of the third qubit based on the read response of the third qubit and the kernel states. Additionally, the method comprises comparing the kernel response of the third qubit with the kernel responses obtained from the calibrated first channel. In addition, the method comprises shifting the phase of the signal of the calibrated first channel in response to a difference between the kernel response of the third qubit and the kernel responses obtained from the calibrated first channel exceeding a threshold value.

Furthermore, in one embodiment of the present disclosure, the method comprises recalibrating the first channel using the phase shifted signal.

Other forms of the embodiments of the method described above are in a system and in a computer program product.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for improving discernment between qubit states in superconducting quantum computers, the method comprising:
shifting a phase of a signal in response to a kernel response not meeting criteria; and
using said phase shifted signal to measure a state of a first qubit in response to said kernel response meeting said criteria using said phase shifted signal.

2. The method as recited in claim 1 further comprising:
continuing to adjust said phase of said phase shifted signal until said kernel response meets said criteria.

3. The method as recited in claim 1 further comprising:
calibrating each of a plurality of channels used for communicating a measured state of qubits.

4. The method as recited in claim 3 further comprising:
reading a plurality of responses of a second qubit set to a first quantum state for a first channel of said plurality of channels as a result of a dynamic circuit performing quantum operations on said second qubit set to said first quantum state; and
reading a plurality of responses of said second qubit set to a second quantum state for said first channel of said plurality of channels as a result of said dynamic circuit performing quantum operations on said second qubit set to said second quantum state.

5. The method as recited in claim 4 further comprising:
generating and recording kernel states to be stored in a kernel with respect to said first quantum state and said second quantum state based on said read responses of said second qubit set to said first quantum state and said second quantum state in response to said first channel completing calibration, wherein kernel responses are obtained from said calibrated first channel using said kernel states.

6. The method as recited in claim 5 further comprising:
setting an excitation state of a third qubit to a quantum state;
reading a response of said third qubit as result of said dynamic circuit performing quantum operations on said third qubit set to said quantum state;
determining a kernel response of said third qubit based on said read response of said third qubit and said kernel states;
comparing said kernel response of said third qubit with said kernel responses obtained from said calibrated first channel; and
shifting said phase of said signal of said calibrated first channel in response to a difference between said kernel response of said third qubit and said kernel responses obtained from said calibrated first channel exceeding a threshold value.

7. The method as recited in claim 6 further comprising:
recalibrating said first channel using said phase shifted signal.

8. A computer program product for improving discernment between qubit states in superconducting quantum computers, the computer program product comprising one or more computer readable storage mediums having program code embodied therewith, the program code comprising programming instructions for:
shifting a phase of a signal in response to a kernel response not meeting criteria; and
using said phase shifted signal to measure a state of a first qubit in response to said kernel response meeting said criteria using said phase shifted signal.

9. The computer program product as recited in claim 8, wherein the program code further comprises the programming instructions for:
continuing to adjust said phase of said phase shifted signal until said kernel response meets said criteria.

10. The computer program product as recited in claim 8, wherein the program code further comprises the programming instructions for:
calibrating each of a plurality of channels used for communicating a measured state of qubits.

11. The computer program product as recited in claim 10, wherein the program code further comprises the programming instructions for:
reading a plurality of responses of a second qubit set to a first quantum state for a first channel of said plurality of channels as a result of a dynamic circuit performing quantum operations on said second qubit set to said first quantum state; and
reading a plurality of responses of said second qubit set to a second quantum state for said first channel of said plurality of channels as a result of said dynamic circuit performing quantum operations on said second qubit set to said second quantum state.

12. The computer program product as recited in claim 11, wherein the program code further comprises the programming instructions for:
generating and recording kernel states to be stored in a kernel with respect to said first quantum state and said second quantum state based on said read responses of said second qubit set to said first quantum state and said second quantum state in response to said first channel completing calibration, wherein kernel responses are obtained from said calibrated first channel using said kernel states.

13. The computer program product as recited in claim 12, wherein the program code further comprises the programming instructions for:
setting an excitation state of a third qubit to a quantum state;
reading a response of said third qubit as result of said dynamic circuit performing quantum operations on said third qubit set to said quantum state;
determining a kernel response of said third qubit based on said read response of said third qubit and said kernel states;
comparing said kernel response of said third qubit with said kernel responses obtained from said calibrated first channel; and
shifting said phase of said signal of said calibrated first channel in response to a difference between said kernel response of said third qubit and said kernel responses obtained from said calibrated first channel exceeding a threshold value.

14. The computer program product as recited in claim 13, wherein the program code further comprises the programming instructions for:
recalibrating said first channel using said phase shifted signal.

15. A system, comprising:
a memory for storing a computer program for improving discernment between qubit states in superconducting quantum computers; and
a processor connected to said memory, wherein said processor is configured to execute program instructions of the computer program comprising:
shifting a phase of a signal in response to a kernel response not meeting criteria; and
using said phase shifted signal to measure a state of a first qubit in response to said kernel response meeting said criteria using said phase shifted signal.

16. The system as recited in claim 15, wherein the program instructions of the computer program further comprise:
continuing to adjust said phase of said phase shifted signal until said kernel response meets said criteria.

17. The system as recited in claim 15, wherein the program instructions of the computer program further comprise:
calibrating each of a plurality of channels used for communicating a measured state of qubits.

18. The system as recited in claim 17, wherein the program instructions of the computer program further comprise:
reading a plurality of responses of a second qubit set to a first quantum state for a first channel of said plurality of channels as a result of a dynamic circuit performing quantum operations on said second qubit set to said first quantum state; and
reading a plurality of responses of said second qubit set to a second quantum state for said first channel of said plurality of channels as a result of said dynamic circuit performing quantum operations on said second qubit set to said second quantum state.

19. The system as recited in claim 18, wherein the program instructions of the computer program further comprise:
generating and recording kernel states to be stored in a kernel with respect to said first quantum state and said second quantum state based on said read responses of said second qubit set to said first quantum state and said second quantum state in response to said first channel completing calibration, wherein kernel responses are obtained from said calibrated first channel using said kernel states.

20. The system as recited in claim 19, wherein the program instructions of the computer program further comprise:
setting an excitation state of a third qubit to a quantum state;
reading a response of said third qubit as result of said dynamic circuit performing quantum operations on said third qubit set to said quantum state;
determining a kernel response of said third qubit based on said read response of said third qubit and said kernel states;
comparing said kernel response of said third qubit with said kernel responses obtained from said calibrated first channel; and
shifting said phase of said signal of said calibrated first channel in response to a difference between said kernel response of said third qubit and said kernel responses obtained from said calibrated first channel exceeding a threshold value.
